(19) United States
(12) Patent Application Publication
(10) Pub. No.: US 2007/0177323 A1
(43) Pub. Date: Aug. 2, 2007

(54) High voltage switch using low voltage cmos transistors

(75) Inventor: Jacobus Govert Sneep, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,194

(22) PCT Filed: May 18, 2005
(86) PCT No.: PCT/IB05/51620

§ 371 Date: Nov. 16, 2006

(30) Foreign Application Priority Data
May 28, 2004 (EP) 04102379.7

(51) Int. Cl. H02H 3/00

(52) U.S. Cl. 361/100

(57) ABSTRACT

The invention relates to an electronic switch capable of rail-to-rail input voltage swing exceeding the voltage rating for a certain technology in which the switch element of the switch is implemented. For example the switch element could be a complementary coupled pair of nMOS and pMOS transistors in a CMOS technology. Two voltage dividers are used to provide a floating supply voltage to the switch element from the supply voltage. This floating supply voltage is always within the supply voltage independent from the input voltage thus allowing a rail-to-rail voltage at the input terminal of the switch while keeping the floating supply voltage within the critical breakdown voltage for the switch element. A switch according to the invention may be formed in standard CMOS technology and it can be implemented to function at switching frequencies up to at least 50 MHz. The switch elements according to the invention can be cascaded thus obtaining an even higher maximum differential input-output voltage than with one switch.

### FIELD OF THE INVENTION

The invention relates to the field of electronic switches, more particularly it relates to electronic switches adapted to implementation within CMOS technology. Especially, the invention relates to the field of electronic CMOS switches accepting high voltages at its terminals exceeding the maximum gate-oxide and/or junction breakdown voltage associated with CMOS technology.

### BACKGROUND OF THE INVENTION

Electronic on/off switches are used within a large amount of electronic equipment and applications. For example CMOS complementary floating switches are widely used due to the number of advantages offered by the CMOS technology compared to other implementation technologies. However, the CMOS technology suffers from an inherent, namely the maximum gate-oxide and/or junction breakdown voltage that typically limits an operable terminal voltage range of CMOS circuits. In modern processes this normally limits the useful terminal voltage range to 5 V or even less, thus forming a major barrier for utilizing CMOS technology in a number of applications, for example in applications where the limited voltage range results in an unacceptable limited dynamic range.

In case of IC-processes that support the use of higher on-chip voltages but have low-voltage ratings for CMOS, two options are known to implement high-voltage floating CMOS switches. 1) To add a thick gate-oxide option and, if required, a high-voltage p/n-well option. This will however increase cost and complexity of the manufacturing process thus leaving this solution unsuited for cost effective mass production. 2) To use circuits utilizing bootstrapping techniques. These prior art examples of switches are shown in FIG. 1 and further described later in section Description of preferred embodiments.

U.S. Pat. No. 6,518,901 describes a CMOS switch providing a higher output voltage via use of a bootstrapping technique. However, the described CMOS switch still suffers from a limited input voltage range and thus still the practical use of such CMOS switch is too limited for many applications.

### SUMMARY OF THE INVENTION

It is an object to provide an electronic switch that can be implemented using standard technologies and still accept input and output voltages exceeding the normal ratings provided by the specific technology. The invention is defined by the independent claims. The dependent claims define advantageous embodiments.

According to a first aspect of the invention, this object is complied with by providing an electrical switch comprising
an electrical switch element having an input terminal, and first and second supply terminals,
a first voltage divider from the input terminal to ground, and
a second voltage divider from the input terminal to a voltage supply line, wherein midpoints of the first and second voltage dividers are connected to respective ones of first and second supply terminals of the switch element.

The first and second voltage dividers are used to provide a floating supply voltage to the supply terminals of the switch element, this floating supply voltage always being within the supply voltage range at the voltage supply line independent of a voltage at the input terminal. Input voltage can thus be driven rail-to-rail while all critical breakdown voltages of the switch element can be kept within the floating supply voltage range. Preferably the switch element comprises an nMOS transistor and a pMOS transistor forming a complementary transistor pair.

The first and second voltage dividers are preferably implemented using at least first and second resistor elements, the first resistor elements being connected to the input terminal. Preferably, the first resistor elements of the first and second voltage dividers exhibit substantially the same resistance value. The second resistor elements of the first and second voltage dividers preferably also exhibit substantially the same resistance value. Preferably a ratio between resistance values of the first and second resistor elements is substantially equal to α/(1−α), wherein ox is within the range 0.0 to 1.0, such as within the range 0.1 to 0.9, such as within the range 0.2 to 0.8 such as within the range 0.3 to 0.7, such as within the range 0.4 to 0.6, such as for example 0.5. The preferred range being dependent on the actual application and technology of the switch element.

In a preferred embodiment each of the first and second resistor elements of the first and second voltage dividers are parallel-connected with separate capacitors. Preferably, the first and second resistor elements are parallel-connected with first and second capacitors, respectively, and wherein a ratio between capacitance values of the first and second capacitors is substantially equal to α/(1−α), wherein α is within the range 0.0 to 1.0, such as within the range 0.1 to 0.9, such as within the range 0.2 to 0.8 such as within the range 0.3 to 0.7, such as within the range 0.4 to 0.6, such as for example 0.5. The preferred range being dependent on the actual application and technology of the switch element. By using capacitors in parallel with the resistors of the voltage dividers it is possible to realize a floating voltage supply to the switch element essentially frequency independent and possible influence from parasitic capacitances are reduced. A further decoupling capacitor may be connected between midpoints of the first and second voltage dividers so as to further decoupling the floating supply voltage provided by the voltage dividers.

The switch element may further comprises an input voltage buffer connected to the input terminal so as to avoid loading of the input terminal in case the switch is used with a high-ohmic source coupled to its input terminal.

Preferably, the switch element is implemented in a technology selected from the group consisting of CMOS, BiCMOS, HVCMOS, DMOS and SOI. The switch element and the voltage dividers may be implemented monolithically.

A second aspect the invention provides a switch system comprising a plurality of electrical switches according to the first aspect. Preferably, the switches are cascaded so as to increase a maximum differential switch voltage of the switching system. Such a switch system is capable of handling an extended maximum differential voltage between input and output.

### BRIEF DESCRIPTION OF THE DRAWINGS

In the following the invention is described with reference to the accompanying figures, of which

FIG. 1 shows diagrams of two prior art examples of solutions to the problem of CMOS on/off switches capable of providing high output voltages,

FIG. 2 shows a diagram of a CMOS switch according to one embodiment of the invention,

FIG. 3 shows an equivalent diagram for the embodiment of FIG. 2,

FIG. 4 shows a preferred embodiment with cascade of a number of the CMOS switches illustrated in FIG. 2,

FIG. 5 shows a diagram of an embodiment of a 10 V switch implemented in BiCMOS technology using 5 V CMOS transistors, and

FIG. 6 shows a graph illustrating measured resistance versus input voltage for the switch of FIG. 5.

### DESCRIPTION OF THE PREFERRED EMBODIMENTS

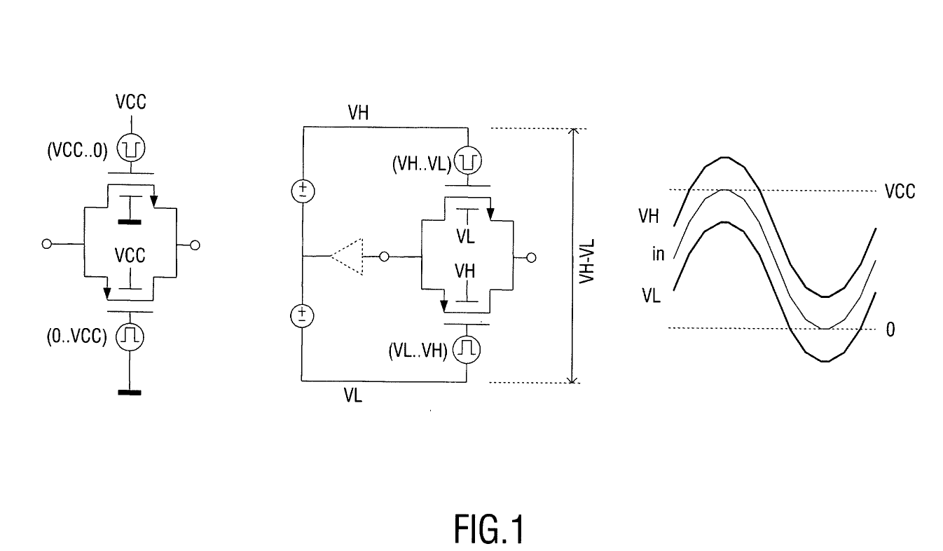

FIG. 1 illustrates the two mentioned prior art solutions to the problem with a limited voltage range of CMOS switches.

The upper part of FIG. 1 shows a standard CMOS complementary switch with a voltage supply VCC. Normally, such switch is limited to input and output voltages within the range of VCC, i.e. usually 5 V or less. A high-voltage version of the switch can be obtained by adding a thick gate-oxide option and (if required) a high-voltage p/n-well option. However, this will increase cost and complexity of the manufacturing process and thus a solution not suited for cost efficient mass production.

The lower part of FIG. I shows a CMOS switch with a bootstrapping circuit and a graph illustrating supply voltage VCC together with the voltages VL and VH and the voltage at the input denoted ‘i’. The dashed line indicates an optional input buffer. In the circuit of lower part of FIG. 1 breakdown limitations are avoided by bootstrapping the gates and/or wells of the MOS transistors. If bootstrapping of wells is required the process should afford isolated wells for both nMOS and pMOS transistors. This is possible for example by SOI, BiCMOS and HVCMOS. A major problem of bootstrapping is that in general the bootstrapped voltages cannot pass the supply voltage. As a result rail-to-rail operation is not possible without deteriorating performance.

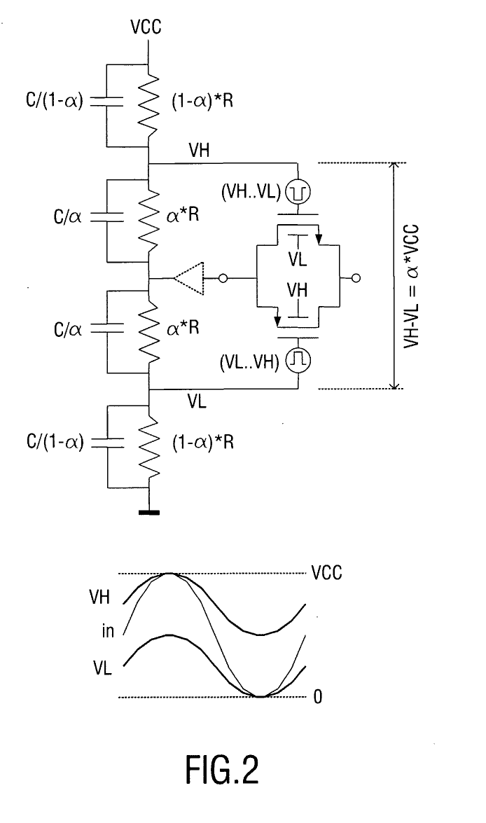

FIG. 2, upper part, shows a CMOS switch circuit according to one embodiment of the invention offering a rail-to-rail voltage swing. The circuit voltage supply is VCC, input is denoted ‘i’, and output is denoted ‘o’. A voltage divider from the input to both ground and supply is used to implement a floating supply voltage VH−VL equal to α times VCC. As seen the voltage divider circuit is implemented using four resistors and four capacitors. The floating supply voltage is always within the supply voltage independent from the input voltage, such as illustrated in the graph in lower part of FIG. 2. This is an important improvement over the prior art circuit shown in lower part of FIG. 1.

In the circuit of FIG. 2, the input voltage V(in) can be driven rail-to-rail while all critical terminal voltages can be kept within the floating supply voltage. This requires that the voltage at terminal ‘out’ be also within the floating supply voltage. In an on-state of the switch this condition is automatically fulfilled, but in an off-state of the switch this depends on the application. As a result the basic switch has rail-to-rail drive at the input terminal, but has still limited differential drive V(in,out) in off-state.

If the switch is not driven from a low-ohmic source an optional voltage buffer, indicated with dashed line, can be added to avoid loading of the input pin with the resistive and capacitive voltage divider. Adding capacitors in parallel to the resistors makes the floating supply voltage theoretically frequency-independent and reduces the influence of parasitic capacitances.

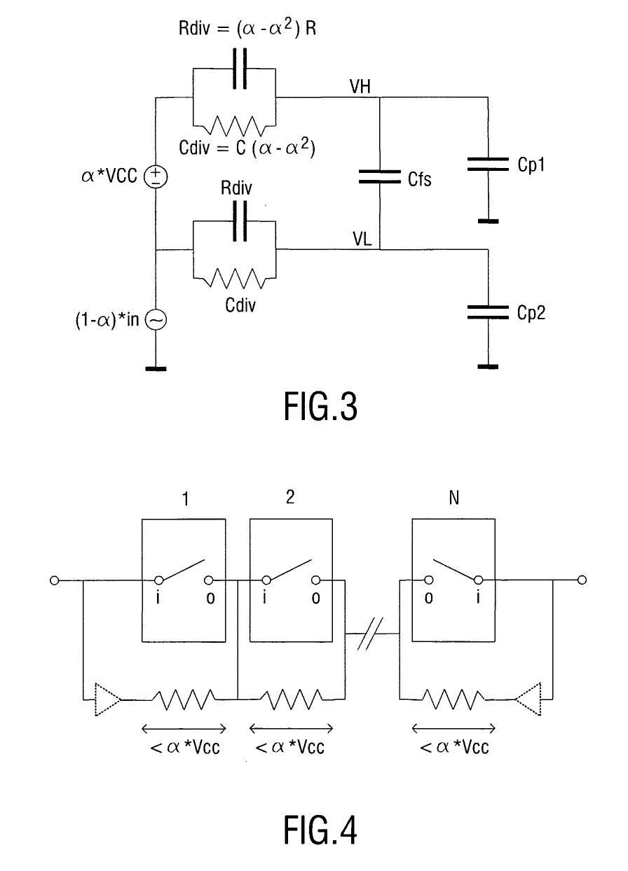

FIG. 3 illustrates this further by means of an equivalent diagram of the circuit of FIG. 2. In FIG. 3 parasitic capacitances Cp1 and Cp2 at both VH and VL are added. In addition a floating supply decoupling capacitor Cfs is added. For low input frequencies the floating supply voltage VH−VL is equal to α times VCC. For high input frequencies VH−VL is equal to:

$$VH - VL \approx α VCC + \frac{Cp 2 - Cp 1}{2 Cfs + Cdiv} * α Vin$$

A difference ΔCp between Cp2 and Cp1 will result in an error of about: αVin* ΔCp/(2Cfs+Cdiv).

Increasing Cfs or Cdiv can reduce the influence of parasitics on the floating supply voltage. Increasing Cfs is favored since it costs four times less capacitance. In addition, Cfs can be an area-efficient gate-oxide capacitor since it has a fixed voltage across its terminals. The voltage division capacitors have to be linear capacitors because their terminal voltages may change from zero to more than half the supply voltage.

The absolute values of VH and VL are also important for correct operation. If Cfs>Cdiv, the high frequency signals at VH and VL are:

$$VH \approx VL \approx \frac{Cdiv}{Cdiv + ( Cp 1 + Cp 2 ) / 2} ( 1 - α ) Vin$$

In order to reduce the influence of the parasitics they should be small compared to Cdiv. It is also possible to compensate the influence of the parasitics by adapting the capacitors used for the capacitive division. In reality this will be problematic since the parasitics will be voltage and layout dependent and they will change depending on the on or off state of the floating switch. In order to have a robust design the parasitics should preferably be much smaller as compared to Cdiv.

FIG. 4 shows a solution where a maximum differential voltage V(in,out) of the switch of FIG. 2 can be extended by providing a switch device having a cascade of N switches of the type shown in FIG. 2. Each of the switches numbered 1, 2 and N are illustrated by the rectangular boxes each having an input ‘i’ and an output ‘o’. In the off-state the differential voltage across each switch should be less than α times VCC. This is easily obtained by means of a resistor ladder. This resistor ladder can be tied directly to both outer sides of the cascaded switches if this parallel resistor is permitted in the off-state. Otherwise optional buffers, indicated with dashed lines, have to be used. These buffers may already be present in the outer switches, see FIG. 2.

By changing the floating supply voltage the resistance of the floating switch in on-state can be controlled. This can for instance be obtained by adapting the two resistors with value (1−α) times R in FIG. 2. A simple linear-mode MOST in series with these resistors would be an option. Since the capacitive division is not influenced, care should be taken about hf-performance.

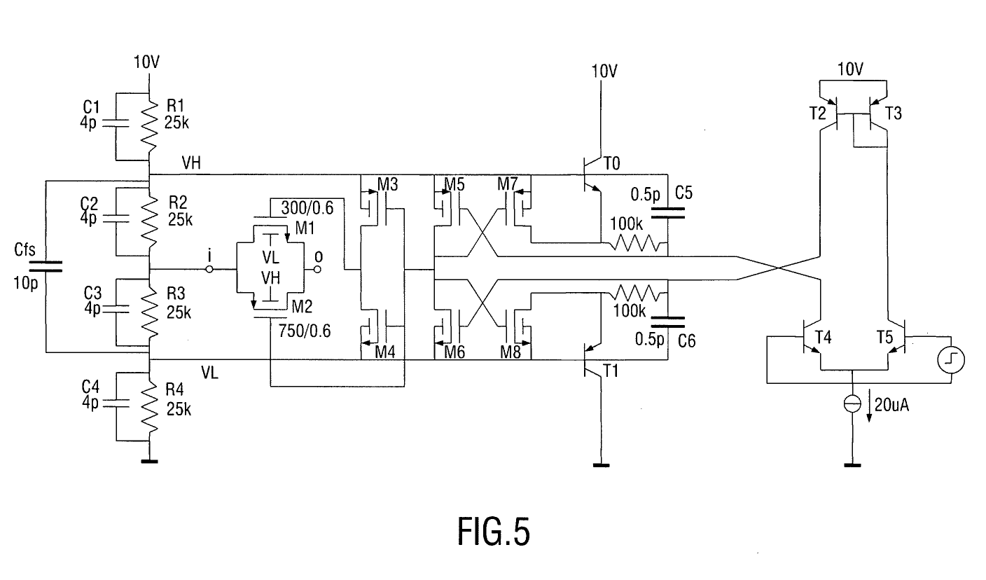

FIG. 5 shows an embodiment of an 11 Ohm floating CMOS switch with 10 V input swing implemented in an 11 V 0.6-μm BiCMOS technology. The BiCMOS technology has both isolated NMOS and PMOS transistors with 5.5 V ratings on Vgs, Vgd and gate-well voltage. The floating supply voltage VH-VL is equal to VCC/2 being the maximum rating of the CMOS transistors. Capacitor C1-C4 are all nitride capacitors with a value of 4 pF in order to be dominant over the parasitic capacitors. In addition, a gate-oxide capacitor, Cfs, of 10 pF is added for extra decoupling of the floating supply as described in connection with FIG. 2.

The on/off control of the switch is transferred from a low-side digital signal to the floating supply by means of a switched 20 μA current. The 20 μA current would cause a 250 mV voltage drop on VH or VL if it would flow through the voltage divider. Adding bipolar transistors T0 and T1, which directly lead the current to the supply and ground, solves this. Using isolated MOS transistors for this function is also possible but it requires some extra circuitry to assure a drain-source voltage within the ratings. The 20 μA current is transformed into a voltage across the 100 kOhm resistor and a base-emitter junction and subsequently drives the gate of M5 or M6. The output of M5 and M6 is a digital signal, which is used to drive the floating switch M1 and M2. M7 and M8 are added to short-circuit the base-emitter junction of T0 and T1 in case there is no current flowing through these transistors. In this way leakage currents through T0 and T1 will not result in gate-drive for M5 and M6. Such a gate-drive could lead to leakage currents in M5 or M6 if Vt of these transistors would be less than Vbe of the bipolar transistors. Small capacitors C5 and C6 are added to avoid turning on M5 or M6 in case of capacitive currents at their gates. These currents will result from component capacitors at high signal frequencies.

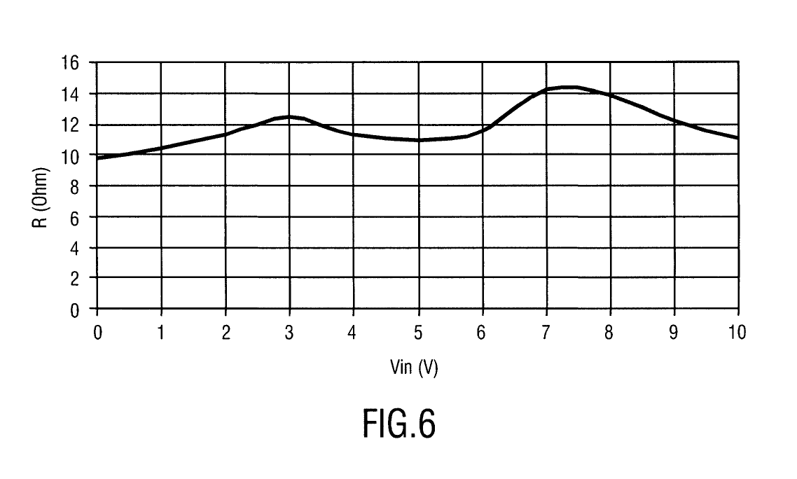

FIG. 6 shows a graph with measured switch resistance versus input voltage for the switch shown in FIG. 5. The typical “camel-like” curve with two shallow peaks for a CMOS switch is stretched by a factor two in the horizontal direction. The switch was tested with 10 Vpp signals for frequencies up to 50 MHz without any problem. As seen from FIG. 6 a switch resistance between approximately 10 and 15 Ohm has been obtained for an input voltage range of 0-10 V.

A rail-to-rail high-voltage floating CMOS switch according to the invention can be implemented in any IC-technology offering isolated nMOS and pMOS transistors. In contrast to traditional bootstrapped CMOS switches the switch circuit according to the invention does never pass the supply and ground voltages at any node. In preferred embodiments a cascading of the proposed switches allows very high voltages across the switch.

On/off switches capable of handling a high voltage range and still easy to implement in standard technologies such as CMOS have a wide range of application. Many electronic devices include components with voltages higher than 5 V that needs to be controlled by an on/off switch. Such devices will be able to benefit from the switches according to the present invention that offers a high switching voltage implemented in standard low cost CMOS technology. Switches according to the invention can even be used at considerable high frequencies thus allowing applications within switching amplifiers etc.

While the invention is susceptible to various modifications and alternative forms, specific embodiments have been shown by way of example in the drawings. It should be understood, however, that the invention is not intended to be limited to the particular forms disclosed. Rather, the invention is to cover all modifications, equivalents, and alternatives falling within the scope of the invention as defined by the appended claims. In the claims, the word “comprising” does not exclude the presence of elements or steps other than those listed in a claim. The word “a” or “an” preceding an element does not exclude the presence of a plurality of such elements. In a device claim enumerating several means, several of these means can be embodied by one and the same item of hardware. The mere fact that certain measures are recited in mutually different dependent claims does not indicate that a combination of these measures cannot be used to advantage.

1. Electrical switch comprising
an electrical switch element having an input terminal, and first and second supply terminals,
a first voltage divider from the input terminal to ground, and
a second voltage divider from the input terminal to a voltage supply line, wherein midpoints of the first and second voltage dividers are connected to respective ones of first and second supply terminals of the switch element.

2. Electrical switch according to claim 1, wherein the switch element comprises a NMOS transistor and a pMOS transistor forming a complementary transistor pair.

3. Electrical switch according to claim 1, wherein each of the first and second voltage dividers are implemented using at least first and second resistor elements, the first resistor elements being connected to the input terminal.

4. Electrical switch according to claim 3, wherein the first resistor elements of the first and second voltage dividers exhibit substantially the same resistance value.

5. Electrical switch according to claim 4, wherein the second resistor elements of the first and second voltage dividers exhibit substantially the same resistance value.

6. Electrical switch according to claim 5, wherein a ratio between resistance values of the first and second resistor elements is substantially equal to α(1−α), wherein α is within the range 0.0 to 1.0.

7. Electrical switch according to claim 3, wherein each of the first and second resistor elements of the first and second voltage dividers are parallel-connected with separate capacitors.

8. Electrical switch according to claim 7, wherein the first and second resistor elements are parallel-connected with first and second capacitors, respectively, and wherein a ratio between capacitance values of the first and second capacitors is substantially equal to α(1−α), wherein α is within the range 0.0 to 1.0.

9. Electrical switch according to claim 1, further comprising a decoupling capacitor connected between midpoints of the first and second voltage dividers.

10. Electrical switch system comprising a plurality of electrical switches according to claim 1, wherein the switches are cascaded so as to increase a maximum differential switch voltage of the switching system.
